(19) United States
(12) Patent Application Publication
(10) Pub. No.: US 2026/0012418 A1
(43) Pub. Date: Jan. 8, 2026

(54) RELAY DEVICE, COMMUNICATION SYSTEM, CONTROL CIRCUIT, STORAGE MEDIUM, AND RELAY METHOD

(71) Applicant: Mitsubishi Electric Corporation, Tokyo (JP)

(72) Inventor: Jun MIZUGUCHI, Tokyo (JP)

(73) Assignee: Mitsubishi Electric Corporation, Tokyo (JP)

(21) Appl. No.: 19/258,325

(22) Filed: Jul. 2, 2025

Related U.S. Application Data
(63) Continuation of application No. PCT/JP2023/004788, filed on Feb. 13, 2023.

(51) Int. Cl. H04L 45/745; H04L 12/46; H04L 69/16

(52) U.S. Cl. CPC H04L 45/745; H04L 12/46; H04L 69/161

(57) ABSTRACT

A relay device includes ports and relays a frame. The communication system includes the relay device. The relay device includes: a reception processing unit that compares a field included in the frame received at one of the ports with a search key of a flow table including an entry in which processing to be executed in a case of being applicable to the search key is set, and determines processing to be executed on the received frame and a port of a transfer destination; a relay processing unit that performs port selection processing such that the frame is transmitted from the determined port and transfers, when the frame is duplicated as the processing to be executed by the reception processing unit, the duplicated frame to a transfer destination determined by the reception processing unit; and a transmission processing unit that transmits the frame from the determined port.

### CROSS-REFERENCE TO RELATED APPLICATION

This application is a continuation application of International Application PCT/JP2023/004788, filed on Feb. 13, 2023, and designating the U.S., the entire contents of which are incorporated herein by reference.

### BACKGROUND OF THE INVENTION

### 1. Field of the Invention

The present disclosure relates to a relay device used for relaying communication, a communication system, a control circuit, a storage medium, and a relay method.

### 2. Description of the Related Art

A relay device compliant with OpenFlow has an advantage of achieving a device configuration capable of flexibly responding to, for example, a processing load, and switching of a communication device or a communication path in the event of a failure by dividing a conventional functional configuration in which a control function and a packet transfer function are integrally mounted, such as learning of a Media Access Control (MAC) address and setting of band control, and adopting an architecture in which the former is separated into a control plane, that is, a C-Plane, and the latter is separated into a user data plane, that is, a U-Plane. A relay device compliant with OpenFlow has, as one function of a packet transfer function, a band control function for a flow and can allocate a band, which is a network resource, to each flow by using the band control function. The flow is a packet group flowing on a network and having a common attribute such as a common destination Internet Protocol (IP) address. Such a technique is disclosed in Non Patent Literature 1, OPEN NETWORKING FOUNDATION, TS-025, “OpenFlow Switch Specification Ver. 1.5.1”, Mar. 26, 2015.

However, according to the above-described conventional technique, a method of determining an appropriate flow band that is an appropriate band value for each flow is, for example, determining the appropriate flow band based on a network bandwidth described as a necessary requirement in an instruction manual of a service or a product that uses a network. Thus, a deviation occurs between an appropriate flow band and a band actually occupied by a flow because many described values are values of maximum bandwidth used in a service or a product, and a deviation also occurs between an appropriate flow band and a band actually used by a service because the described values are static values. This causes deterioration of network utilization efficiency, which is problematic. Additionally, from the viewpoint of an administrator who manages and operates a network using a control controller, because of the lack of techniques to recognize when and how much network bandwidth a user who uses the network wants to use a service, band control in the unit of flow becomes impossible particularly in a large-scale network, and the user has to perform band control in units of terminals connected to the network and cannot perform band control in the unit of flow, which is problematic.

### SUMMARY OF THE INVENTION

To solve the problem, the present disclosure provides a relay device in a communication system, the relay device including a plurality of ports and to relay a frame, the communication system including the relay device. The relay device comprises: a reception processing unit to compare a field with a search key of a flow table, the field being included in the frame received at a certain one of the ports, the flow table including the search key and an entry in which processing to be executed in a case of being applicable to the search key is set, and to determine processing to be executed on the received frame and a port of a transfer destination; a relay processing unit to perform port selection processing such that the frame is transmitted from the port determined by the reception processing unit, and, when the frame is duplicated as the processing to be executed by the reception processing unit, to transfer the duplicated frame to a transfer destination determined by the reception processing unit; and a transmission processing unit to transmit the frame from the port determined by the reception processing unit.

### BRIEF DESCRIPTION OF THE DRAWINGS

FIG. 1 is a diagram illustrating an exemplary configuration of a communication system according to a first embodiment;

FIG. 2 is a diagram illustrating an exemplary configuration of a relay device according to the first embodiment;

FIG. 3 is a diagram illustrating an example of internal configurations of a reception processing unit, a relay processing unit, and a transmission processing unit that implement a Transmission Control Protocol (TCP) flag match scheme in the relay device according to the first embodiment;

FIG. 4 is a diagram illustrating examples of reception flow tables included in the reception processing unit of the relay device according to the first embodiment;

FIG. 5 is a diagram illustrating an example of a configuration of Ethernet (registered trademark) frames transmitted and received by the relay device according to the first embodiment;

FIG. 6 is a diagram illustrating an example of a state transition of a TCP socket performed by each device serving as a transmission source or a transmission destination of an Ethernet frame in the communication system according to the first embodiment;

FIG. 7 is a diagram illustrating an example of a delay time between a joystick and a server via the relay device according to the first embodiment and of an exchange of Ethernet frames at the time of establishing a three-way TCP connection;

FIG. 8 is a flowchart illustrating an example of an operation of the relay device according to the first embodiment;

FIG. 9 is a flowchart illustrating an example of reception processing in a reception processing unit of the relay device according to the first embodiment;

FIG. 10 is a flowchart illustrating an example of transmission processing in a transmission processing unit of the relay device according to the first embodiment;

FIG. 11 is a diagram illustrating an exemplary configuration of a communication system according to a second embodiment;

FIG. 12 is a diagram illustrating an exemplary configuration of a relay device according to a third embodiment;

FIG. 13 is a diagram illustrating examples of reception flow tables included in a reception processing unit of the relay device according to the third embodiment;

FIG. 14 is a diagram illustrating an example of a delay time table managed by a control device according to a fourth embodiment;

FIG. 15 is a diagram illustrating an example of a maximum throughput for a Round Trip Time (RTT) estimated by the control device according to the fourth embodiment;

FIG. 16 is a diagram illustrating an exemplary configuration of processing circuitry in a case where a processor and a memory implement processing circuitry that implements the relay device according to the first to fourth embodiments; and

FIG. 17 is a diagram illustrating an example of processing circuitry in a case where dedicated hardware constitutes processing circuitry that implements the relay device according to the first embodiment.

### DETAILED DESCRIPTION OF THE PREFERRED EMBODIMENTS

Hereinafter, with reference to the drawings, a description will be given in detail of a relay device, a communication system, a control circuit, a storage medium, and a relay method according to embodiments of the present disclosure.

### First Embodiment

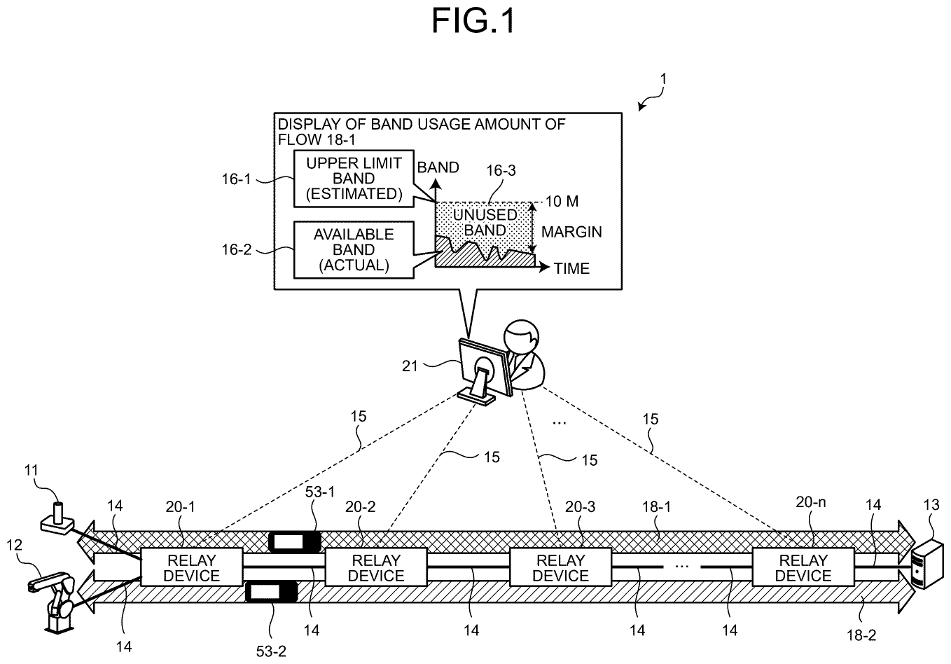

FIG. 1 is a diagram illustrating an exemplary configuration of a communication system 1 according to a first embodiment. The communication system 1 is a network including a joystick 11 that is a terminal, a robot 12 that is a terminal, a server 13, relay devices 20-1 to 20-n, and a control device 21. In FIG. 1, the joystick 11 transmits operation information and the like from the joystick 11 to the server 13 by a flow 18-1 using an Ethernet frame 53-1 using TCP/IPv4, which is a communication protocol. The flow 18-1 is a flow used in communication between the joystick 11 and the server 13. Additionally, the robot 12 transmits, for example, position information of the robot 12 to the server 13 and receives, for example, a command for a moving operation from the server 13 by a flow 18-2 using an Ethernet frame 53-2 using TCP/IPv4, which is a communication protocol. The flow 18-2 is a flow used in communication between the robot 12 and the server 13.

In the following description, the joystick 11 and the robot 12 may each be referred to as a terminal when not distinguished from each other. In the communication system 1, the relay devices 20-1 to 20-n relay the communication between the terminal and the server via main signal paths 14. The communication system 1 is a system that relays a frame transmitted from a transmission source device to a transmission destination device when the terminal is the transmission source device and the server 13 is the transmission destination device, or when the server 13 is the transmission source device and the terminal is the transmission destination device. In the communication system 1, the relay devices 20-1 to 20-n include a plurality of ports and relay frames as described later. The relay devices 20-1 to 20-n are connected to the control device 21 via control signal paths 15. The control device 21 controls operations of the relay devices 20-1 to 20-n.

In the present embodiment, the description will be given with a case in mind where the communication system 1 is an Ethernet Network in the Institute of Electrical and Electronics Engineers (IEEE), but this is a non-limiting example. The communication system 1 may be based on another standard. Additionally, as communication means in the main signal path 14, the description will be given with the assumption that communication using an optical signal is implemented, but a signal transmitted in the main signal path 14 may be an electrical signal or a wireless signal. Furthermore, a description will be given by taking a physical transmission rate in the main signal path 14 as 1 Gbps, but there is no restriction on the physical transmission rate. In the following description, the relay devices 20-1 to 20-n may each be simply referred to as a relay device 20 when not distinguished from each other. Additionally, the Ethernet frames 53-1 and 53-2 may each be simply referred to as an Ethernet frame 53 when not distinguished from each other. Furthermore, the flows 18-1 and 18-2 may each be simply referred to as a flow 18 when not distinguished from each other.

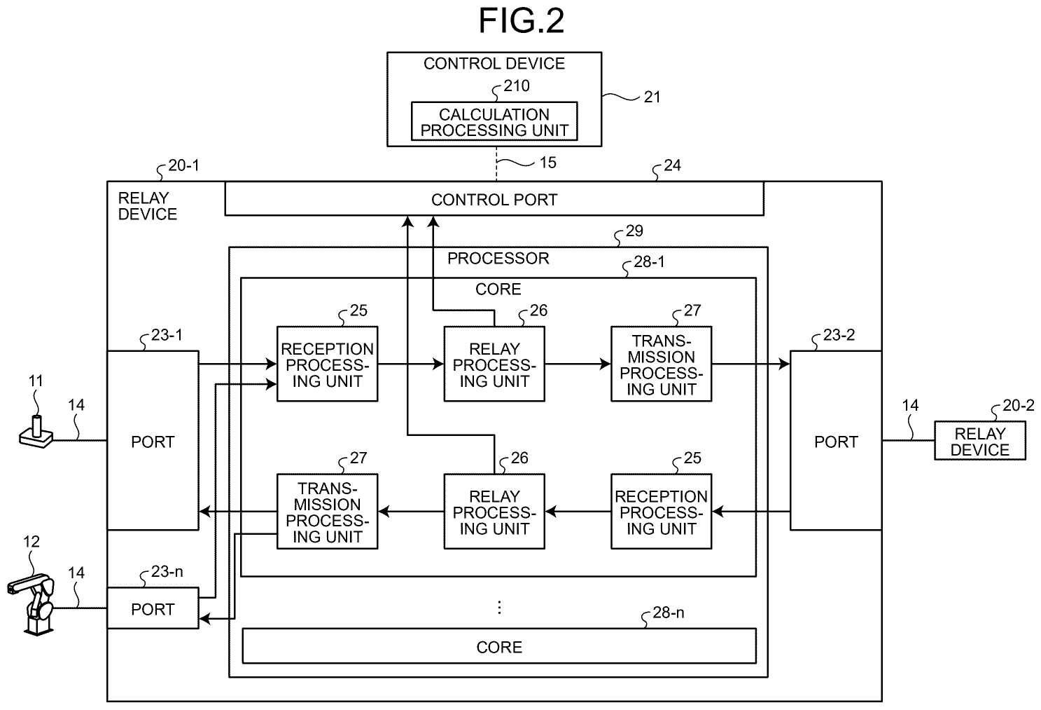

FIG. 2 is a diagram illustrating an exemplary configuration of the relay device 20-1 according to the first embodiment. The relay device 20-1 includes cores 28-1 to 28-n that perform arithmetic operation processing, ports 23-1 to 23-n, and a control port 24. The cores 28-1 to 28-n are constituted by one processor 29. The core 28-1 includes two reception processing units 25, two relay processing units 26, and two transmission processing units 27. In the following description, the ports 23-1 to 23-n may each be simply referred to as the port 23 when not distinguished from each other. In the example of FIG. 2, the port 23-1 is connected to the joystick 11 via the main signal path 14, the port 23-2 is connected to the relay device 20-2, which is another relay device 20, via the main signal path 14, and the port 23-n is connected to the robot 12 via the main signal path 14. The relay device 20-1, in response to receiving the Ethernet frames 53 at the respective ports 23, performs reception processing on the Ethernet frames 53 in the reception processing units 25 and transmits the Ethernet frames 53 from the respective ports 23-1 to 23-n via the relay processing units 26 and the transmission processing units 27 or from the control port 24 via the relay processing units 26. Additionally, as illustrated in FIG. 2, the control device 21 includes a calculation processing unit 210. The calculation processing unit 210, in response to receiving the Ethernet frame 53 transmitted from the relay device 20, calculates, using the Ethernet frame 53, a delay time that occurs in the communication system 1 and calculates, using the delay time, a transmission band to be set in the relay device 20.

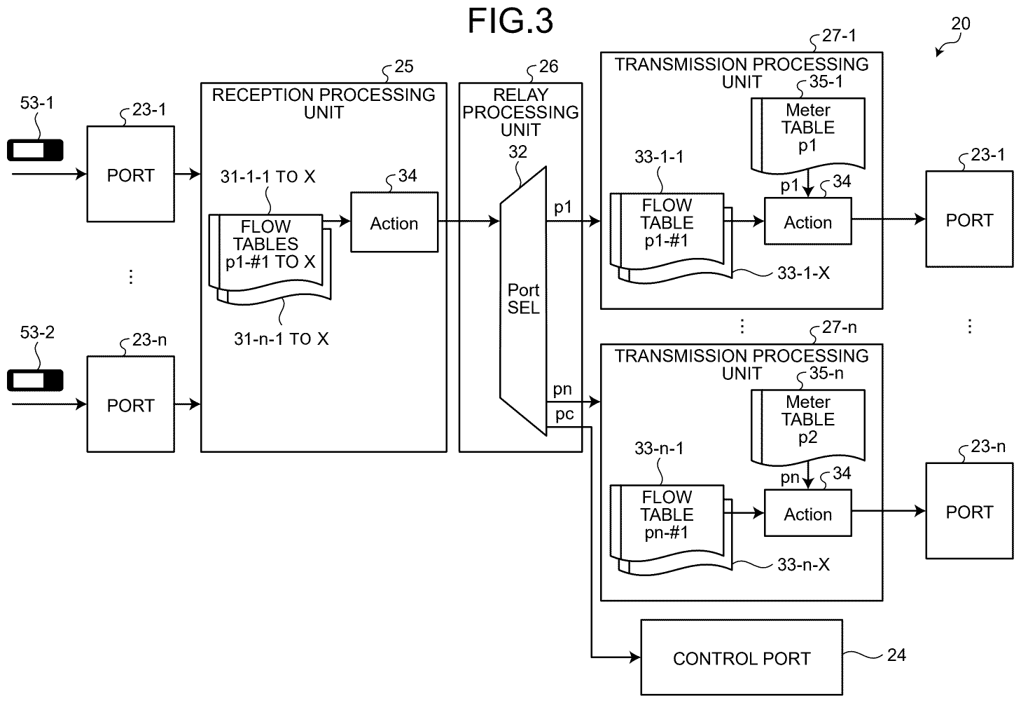

FIG. 3 is a diagram illustrating an example of internal configurations of the reception processing unit 25, the relay processing unit 26, and the transmission processing unit 27 that implement the TCP flag match scheme in the relay device 20 according to the first embodiment. As illustrated in FIG. 3, the reception processing unit 25 compares, for the Ethernet frames 53 received at the ports 23-1 to 23-n, respective search keys (to be described later) of the reception flow tables 31-1-1 to 31-n-X with respective fields (to be described later) in the Ethernet frames 53. The search keys include MAC dst 40-1 and the like. The fields include MAC dst 50-1 and the like. In the following description, the reception flow tables 31-1-1 to 31-n-X may each be simply referred to as a reception flow table 31 when not distinguished from each other. Additionally, the reception flow table may be simply referred to as a flow table. When the comparison gives a match, the reception processing unit 25 adds the frame lengths or the number of frames of the Ethernet frames 53, which are given a match, to Count 41-2 of the corresponding reception flow tables 31, executes the operation specified by Action 34 of the corresponding reception flow tables 31, and performs control to output the Ethernet frames 53 to either the transmission destination ports, that is, the ports 23-1 to 23-n or the control port 24. Examples of the operation specified in the Action 34 include outputting the Ethernet frames to the transmission destination ports, changing a Type of Service (ToS) value of an IPv4 header, and the like. Note that, the transmission processing units 27-1 to 27-n illustrated in FIG. 3 correspond to one transmission processing unit 27 illustrated in FIG. 2.

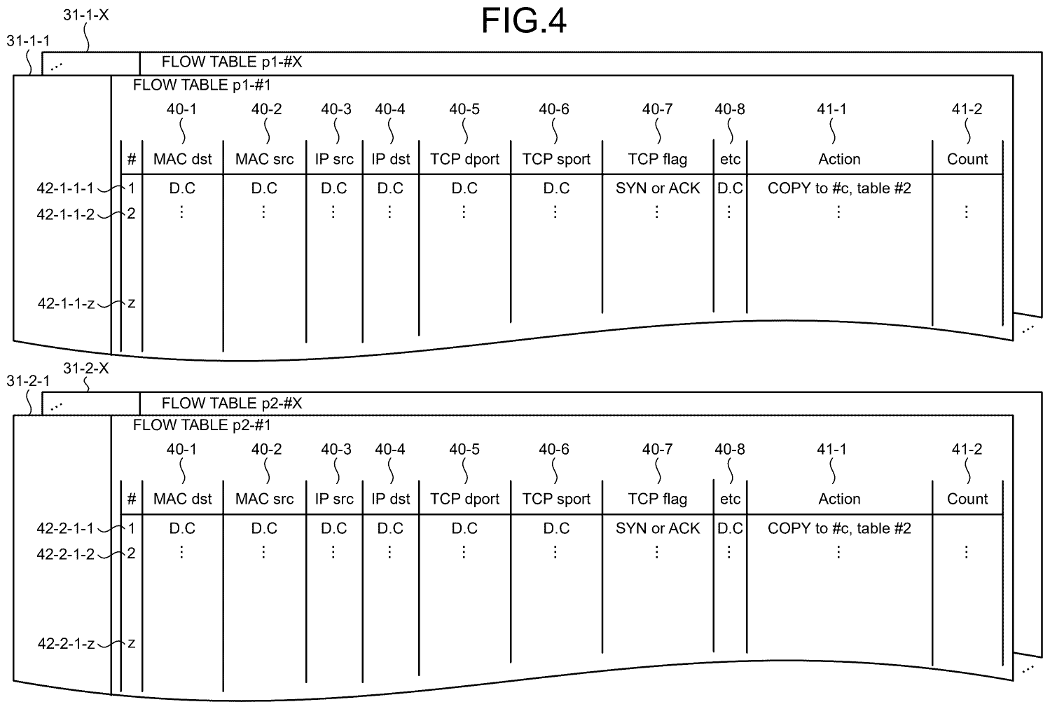

FIG. 4 is a diagram illustrating examples of the reception flow tables 31-1-1 to 31-2-X included in the reception processing units 25 of the relay device 20 according to the first embodiment. As illustrated in FIG. 4, the search keys include the MAC dst 40-1, MAC src 40-2, IP src 40-3, IP dst 40-4, TCP dport 40-5, TCP sport 40-6, TCP flag 40-7, and etc 40-8. For example, the reception processing units 25 each execute an operation described in Action 41-1 as an operation of a corresponding one of matching entries 42-1-1-1 to 42-1-1-z and 42-2-1-1 to 42-2-1-z, and add the frame length or the number of frames to the Count 41-2 as statistical information. The operation described in the Action 41-1 is the operation specified in the Action 34 described above. Examples of the operation described in the Action 41-1 include outputting the Ethernet frame to the specified transmission destination port, searching in the reception flow table 31 specified by a flow table number to be searched next, changing the TOS value of the IPv4 header, and the like.

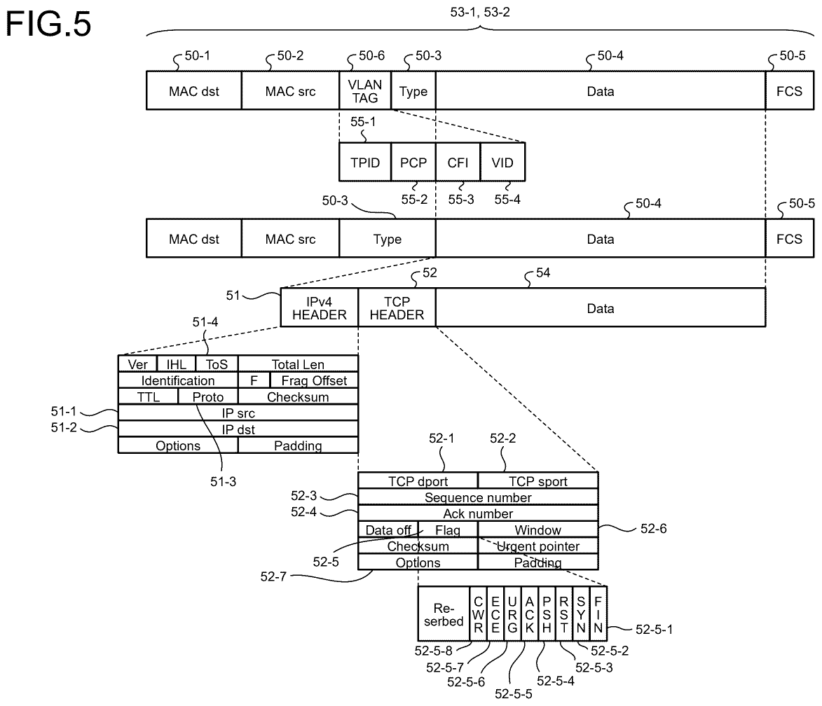

FIG. 5 is a diagram illustrating an example of a configuration of the Ethernet frames 53-1 and 53-2 transmitted and received by the relay device 20 according to the first embodiment. As illustrated in FIG. 5, the Ethernet frames 53-1 and 53-2 include the MAC dst 50-1, MAC src 50-2, Type 50-3, Data 50-4, and FCS 50-5. When a VLAN tag is added to the Ethernet frame 53, the Ethernet frame 53 further includes VLAN TAG 50-6. The VLAN TAG 50-6 includes TPID 55-1, PCP 55-2, CFI 55-3, and VID 55-4. The Data 50-4 includes an IPv4 header 51, a TCP header 52, and Data 54. The IPv4 header 51 includes IP src 51-1, IP dst 51-2, Proto 51-3, ToS 51-4, and the like. The TCP header 52 includes TCP dport 52-1, TCP sport 52-2, Sequence number 52-3, Ack number 52-4, Flag 52-5, Window 52-6, Options 52-7, and the like. The Flag 52-5 includes FIN 52-5-1, SYN 52-5-2, RST 52-5-3, PSH 52-5-4, ACK 52-5-5, URG 52-5-6, ECE 52-5-7, CWR 52-5-8, and the like.

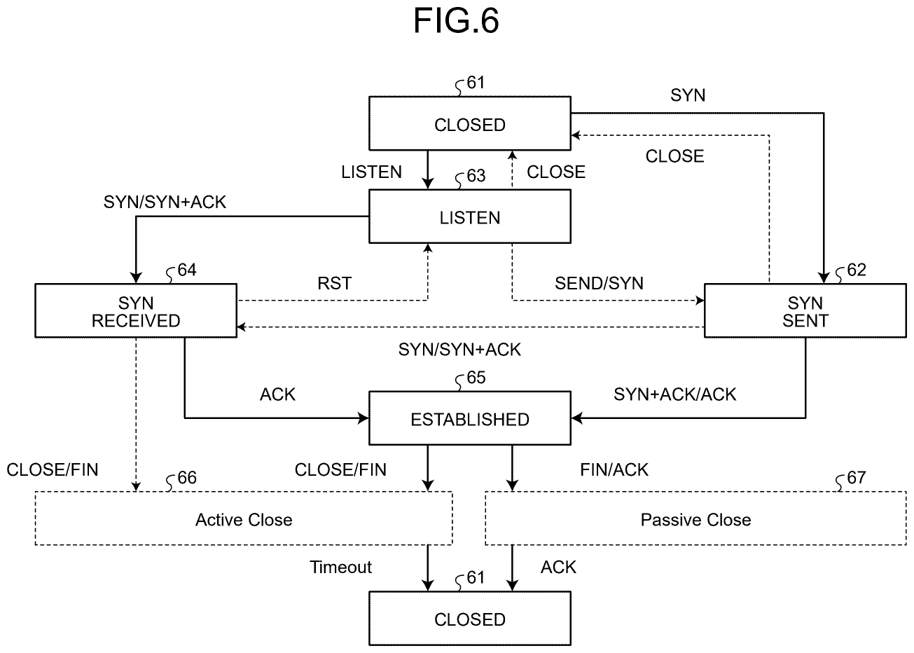

FIG. 6 is a diagram illustrating an example of a state transition of a TCP socket performed by each device serving as a transmission source or a transmission destination of the Ethernet frame 53 in the communication system 1 according to the first embodiment. The joystick 11, the robot 12, and the server 13 each perform the state transition of the TCP socket illustrated in FIG. 6, and as a result of this, start from CLOSED 61, notify each other of their connection states using the respective flags of the FIN 52-5-1 to the CWR 52-5-8 of the Flag 52-5 of the Ethernet frame 53 illustrated in FIG. 5 at the time of establishing the three-way TCP connection, and transition to ESTABLISHED 65 via at least one of SYN SENT 62, LISTEN 63, and SYN RECEIVED 64. Thus, the joystick 11, the robot 12, and the server 13 can each pass the Data 54 of the Ethernet frame 53 to the corresponding application. Additionally, the joystick 11, the robot 12, and the server 13 each perform the state transition of the TCP socket illustrated in FIG. 6, and as a result of this, transition from the ESTABLISHED 65 to the CLOSED 61 via Active Close 66 or Passive Close 67.

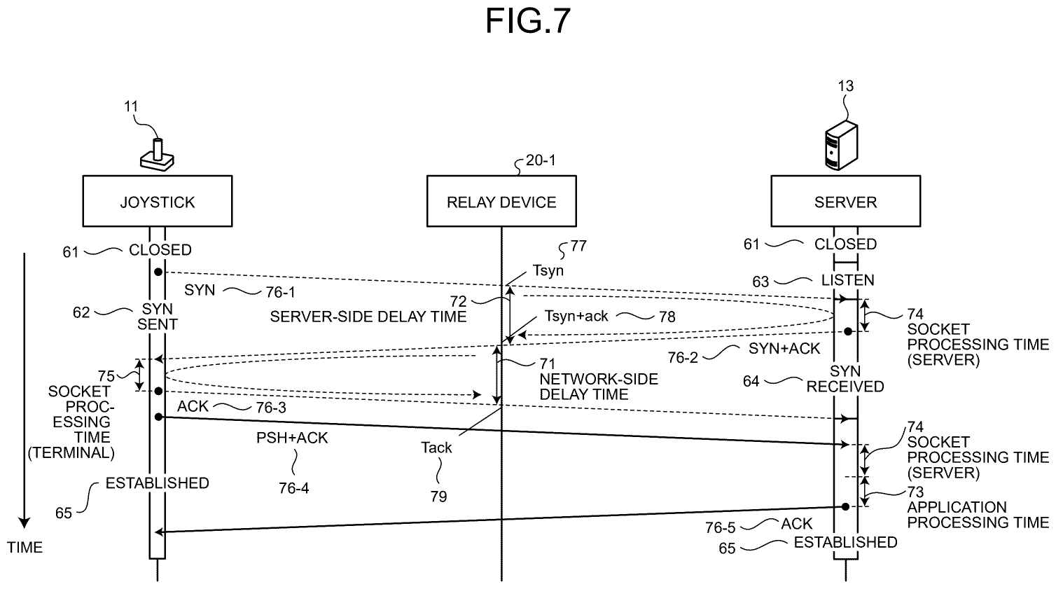

FIG. 7 is a diagram illustrating an example of a delay time between the joystick 11 and the server 13 via the relay device 20-1 according to the first embodiment and an exchange of the Ethernet frames 53 at the time of establishing a three-way TCP connection. The joystick 11 transmits, to the server 13, SYN 76-1 that is the Ethernet frame 53 in which a bit of the SYN 52-5-2 of the Flag 52-5 is enabled for establishment of the TCP connection with the server 13, and makes the state transition of the TCP socket from the CLOSED 61 to the SYN SENT 62.

On the other hand, the server 13 makes the state transition of the TCP socket from the CLOSED 61 to the LISTEN 63 after starting the service, and waits for establishment of the TCP connection from the terminal. The server 13, in response to receiving the SYN 76-1, returns SYN+ACK 76-2 that is the Ethernet frame 53 in which bits of the SYN 52-5-2 and the ACK 52-5-5 of the Flag 52-5 are enabled, to the joystick 11 after the elapse of a socket processing time (server) 74, and makes the state transition of the TCP socket from the LISTEN 63 to the SYN RECEIVED 64.

The joystick 11, in response to receiving the SYN+ACK 76-2 transmitted from the server 13, returns ACK 76-3 that is the Ethernet frame 53 in which a bit of the ACK 52-5-5 of the Flag 52-5 is enabled, to the server 13 after the elapse of a socket processing time (terminal) 75, and makes the state transition of the TCP socket from the SYN SENT 62 to the ESTABLISHED 65.

Additionally, in the example of FIG. 7, the joystick 11 transmits PSH+ACK 76-4 that is the Ethernet frame 53. After receiving the PSH+ACK 76-4, the server 13 passes the Data 54 of the PSH+ACK 76-4 to an application after the elapse of the socket processing time (server) 74 and transmits ACK 76-5 that is the Ethernet frame 53 after the elapse of application processing time 73. Additionally, the server 13 makes the state transition of the TCP socket from the SYN RECEIVED 64 to the ESTABLISHED 65. The joystick 11 receives the ACK 76-5. Thus, the communication is performed between the joystick 11 and the server 13. In response to the state transition to the ESTABLISHED 65, both the joystick 11 and the server 13 pass the Data 54 of the Ethernet frame 53 to an application whose TCP socket corresponds to the TCP dport 52-1. Thus, the joystick 11 and the server 13 perform application processing in accordance with the Data 54.

The relay device 20-1 relays the communication between the joystick 11 and the server 13. The relay device 20-1 or the control device 21 calculates network-side delay time 71 including the socket processing time (terminal) 75 from the communication of the SYN+ACK 76-2, which is the Ethernet frame 53, and the ACK 76-3, which is the Ethernet frame 53 corresponding to the SYN+ACK 76-2. Additionally, the relay device 20-1 or the control device 21 calculates server-side delay time 72 including the socket processing time (server) 74 from the SYN 76-1, which is the Ethernet frame 53, and the SYN+ACK 76-2, which is the Ethernet frame 53 corresponding to the SYN 76-1. Note that, in the control device 21, the calculation processing unit 210 actually calculates the network-side delay time 71, the server-side delay time 72, and the like. However, for simplicity, the description is made with the control device 21 being the subject. The same applies to the following.

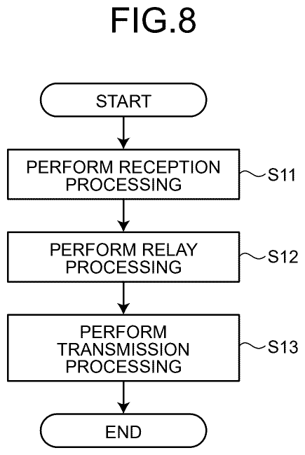

FIG. 8 is a flowchart illustrating an example of the operation of the relay device 20-1 according to the first embodiment. In the relay device 20-1, the reception processing unit 25 performs reception processing on a frame received at any of the ports 23-1 to 23-n (step S11). Details of the reception processing performed by the reception processing unit 25 will be described later. The relay processing unit 26 performs relay processing such that the frame is transmitted from the port determined in the reception processing of the reception processing unit 25 (step S12). The transmission processing unit 27 performs transmission processing of transmitting the frame from the port determined in the reception processing of the reception processing unit 25 (step S13). Details of the transmission processing performed by the transmission processing unit 27 will be described later.

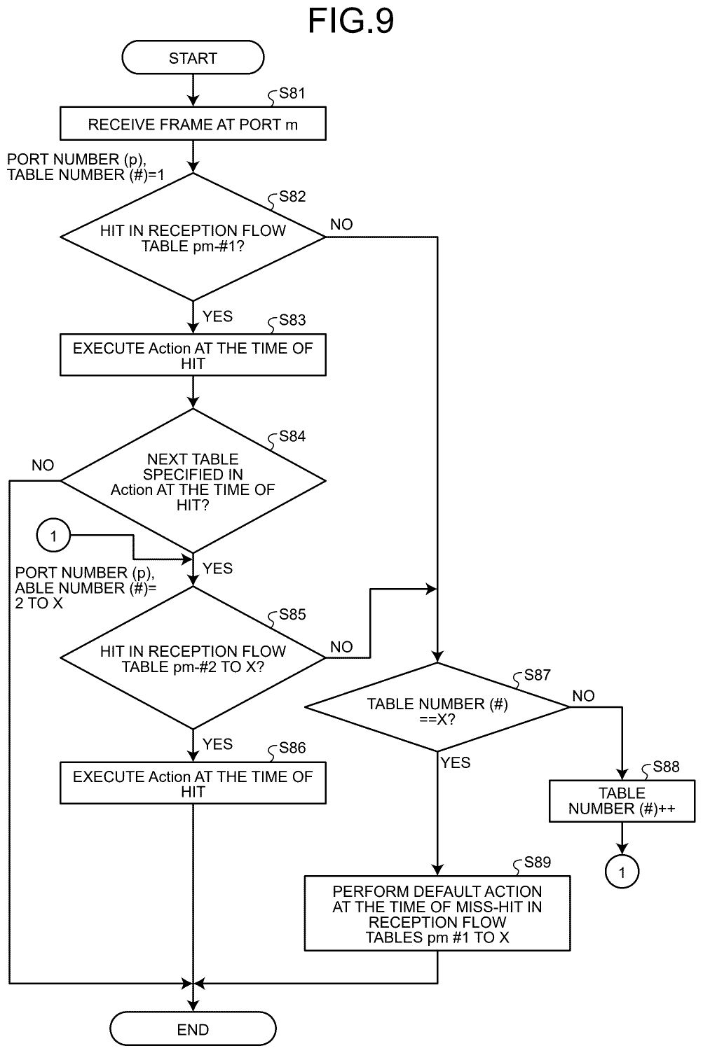

FIG. 9 is a flowchart illustrating an example of the reception processing in the reception processing unit 25 of the relay device 20-1 according to the first embodiment. FIG. 9 illustrates details of the reception processing in step S11 of the flowchart illustrated in FIG. 8. In FIG. 9, for the simplicity of description, a target port 23-m among the ports 23-1 to 23-n is supposed to be a port m, and the reception flow tables 31-m-1 to X are supposed to be reception flow tables pm-#1 to X. Here, m represents a port number and is an integer of 1≤m≤n. Here, 1 to X at the end of the reception flow tables pm-#1 to X represent table numbers.

In the relay device 20-1, when the reception processing unit 25 receives, at the port m, the frame, that is, the Ethernet frame 53 (step S81), the reception processing unit 25 determines whether there is a hit in the reception flow table pm-#1 (step S82). When there is a hit in the reception flow table pm-#1 (step S82: Yes), the reception processing unit 25 executes the Action 41-1 described in the reception flow table pm-#1 as the Action 34 at the time of the hit (step S83). When the next table is not specified, that is, the reception flow tables pm-#2 to X are not specified in the Action 34 at the time of the hit (step S84: No), the reception processing unit 25 ends the reception processing. When the next table is specified, that is, the reception flow tables pm-#2 to X are specified in the Action 34 at the time of the hit (step S84: Yes), the reception processing unit 25 determines whether there is a hit in the reception flow tables pm-#2 to X (step S85). When there is a hit in the reception flow tables pm-#2 to X (step S85: Yes), the reception processing unit 25 executes the Action 41-1 described in the reception flow tables pm-#2 to X as the Action 34 at the time of the hit (step S86), and ends the reception processing.

When there is no hit in the reception flow table pm-#1 (step S82: No) or when there is no hit in the reception flow tables pm-#2 to X (step S85: No), the reception processing unit 25 determines whether the table number is X (step S87). When the table number is not X (step S87: No), the reception processing unit 25 increments the table number (step S88), and proceeds to the processing of step S85. The subsequent processing is similar to the above-described processing. When the table number is X (step S87: Yes), the reception processing unit 25 performs a predetermined default action at the time of a miss-hit in the reception flow tables pm-#1 to X (step S89).

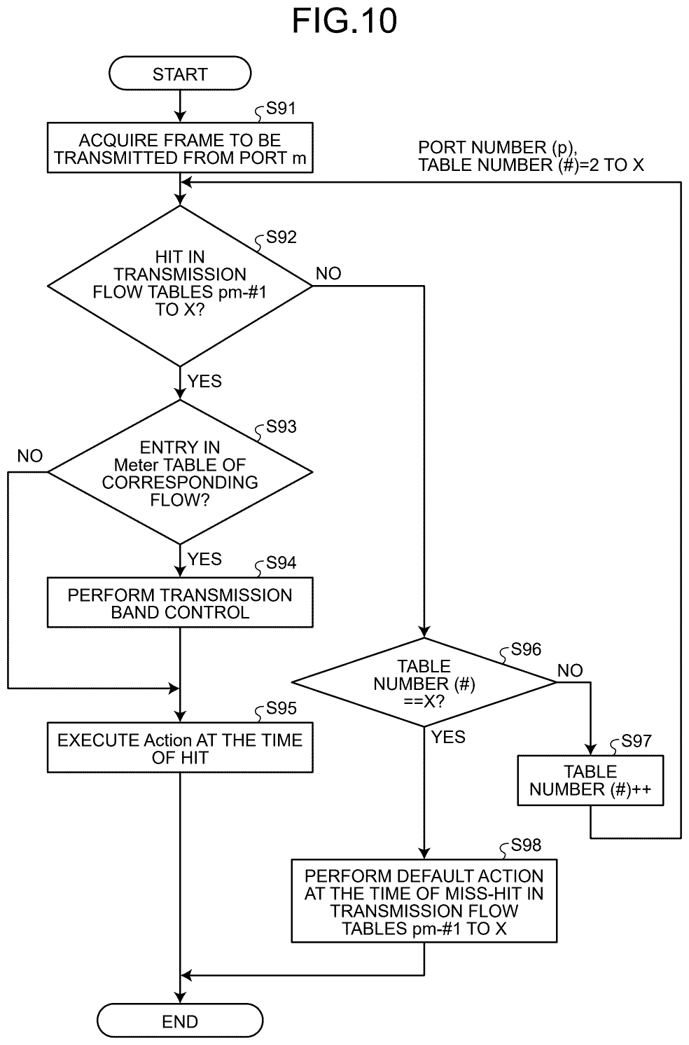

FIG. 10 is a flowchart illustrating an example of the transmission processing in the transmission processing units 27-1 to 27-n of the relay device 20-1 according to the first embodiment. FIG. 10 illustrates details of the transmission processing in step S13 of the flowchart illustrated in FIG. 8. In FIG. 10, for the simplicity of description, the target port 23-m among the ports 23-1 to 23-n is supposed to be the port m, and transmission flow tables 33-m-1 to X are supposed to be transmission flow tables pm-#1 to X. Here, m represents a port number and is an integer of 1≤m≤n. Here, 1 to X at the end of the transmission flow tables pm-#1 to X represent table numbers.

In the relay device 20-1, when the transmission processing unit 27-m acquires a frame to be transmitted from the port m, that is, the Ethernet frame 53 from the relay processing unit 26 (step S91), the transmission processing unit 27-m determines whether there is a hit in the transmission flow tables pm-#1 to X (step S92). When there is a hit in the transmission flow tables pm-#1 to X (step S92: Yes), the transmission processing unit 27-m determines whether there is an entry in a Meter table 35-m of the corresponding flow 18 (step S93). When there is an entry (step S93: Yes), the transmission processing unit 27-m performs transmission band control based on the entry (step S94). When there is no entry (step S93: No), or after the processing of step S94, the transmission processing unit 27-m executes the Action 41-1 described in the transmission flow tables pm-#1 to X as the Action 34 at the time of the hit (step S95).

When there is no hit in the transmission flow tables pm-#1 to X (step S92: No), the transmission processing unit 27-m determines whether the table number is X (step S96). When the table number is not X (step S96: No), the transmission processing unit 27-m increments the table number (step S97), and proceeds to the processing of step S92. The subsequent processing is similar to the above-described processing. When the table number is X (step S96: Yes), the transmission processing unit 27-m performs a predetermined default action at the time of a miss-hit in the transmission flow table pm-#1 to X (step S98).

Next, the operation of the relay device 20 will be described. As illustrated in FIG. 1, the communication system 1 achieves the communication flow 18-1 between the joystick 11 and the server 13 and the communication flow 18-2 between the robot 12 and the server 13 by the relay devices 20-1 to 20-n relaying the Ethernet frames 53. In the example of FIG. 1, the control device 21 displays the status of a band usage amount of the flow 18-1, and there is an unused band 16-3 as a difference between a set estimated upper limit band 16-1 and an actual available band 16-2.

FIG. 2 illustrates the internal configuration of the relay device 20-1 as described above, in which the joystick 11 is connected to the port 23-1 via the main signal path 14, the robot 12 is connected to the port 23-n via the main signal path 14, the relay device 20-2 is connected to the port 23-2 via the main signal path 14, and the control device 21 is connected to the control port 24 via the control signal path 15. The relay device 20-1 transmits the Ethernet frames 53 received at the respective ports from the ports 23-1 to 23-n via the reception processing units 25, the relay processing units 26, and the transmission processing units 27, or from the control port 24 via the reception processing units 25 and the relay processing units 26. Note that, the present embodiment describes an example in which each of the reception processing units 25, the relay processing units 26, and the transmission processing units 27 resides in the core 28-1 in the processor 29, but the present embodiment is not limited thereto. Each of the reception processing units 25, the relay processing units 26, and the transmission processing units 27 may reside across a plurality of cores 28 or may reside across a plurality of processors 29.

Hereinafter, the operation of the relay device 20-1 illustrated in FIG. 3 will be described together with the reception flow tables 31-1-1 to 31-2-X illustrated in FIG. 4, the three-way TCP handshake illustrated in FIG. 7, the operation of the reception processing illustrated in FIG. 9, and the operation of the transmission processing illustrated in FIG. 10. In the following description, the three-way TCP handshake may be simply referred to as a three-way handshake.

FIG. 3 illustrates the reception processing unit 25, the relay processing unit 26, and the transmission processing unit 27 of the relay device 20-1 as described above. For the Ethernet frames 53 received at the ports 23-1 to 23-n, the reception processing unit 25 determines the ports 23-1 to 23-n or the control port 24 to be the transmission destination and the Action 34, based on the reception flow tables 31-1-1 to 31-n-X corresponding to the reception ports. The transmission processing units 27-1 to 27-n corresponding to the ports 23-1 to 23-n, which are the transmission destinations, perform search processing using the transmission flow tables 33-1-1 to 33-n-X to determine the Action 34 to be executed at the transmission destinations.

For example, in FIG. 7, when the SYN 76-1 that is the Ethernet frame 53 is transmitted from the joystick 11 to the server 13, the reception processing unit 25 of the relay device 20-1 that has received the SYN 76-1 performs the search processing in accordance with the flowchart illustrated in FIG. 9, extracts, as the search key, a field such as the MAC dst 50-1 illustrated in FIG. 5 from the SYN 76-1 received at the port 23-1, and performs the search processing on each entry of the reception flow tables 31-1-1 to X (steps S82 and S85 in FIG. 9).

FIG. 4 illustrates the reception flow table 31-1-1, and the entry 42-1-1-1 is determined to be a hit entry when the bit of the SYN 52-5-2 or the ACK 52-5-5 is enabled in the Flag 52-5 of the received SYN 76-1.

The reception processing unit 25 continues, as the Action 34, the frame copy to the control port 24 described in the Action 41-1 of the reception flow table 31-1-1 and the search in the reception flow table 31-1-2. Thus, the reception processing unit 25 can continue the search processing to the reception flow table 31-1-2 and subsequent tables, and as a result, can hit the entry that points to the server 13. The reception processing unit 25, when hitting the entry that points to the server 13 in the search processing, outputs the SYN 76-1 to the relay processing unit 26. The relay processing unit 26 outputs, in a Port SEL 32, the SYN 76-1 to the transmission processing unit 27-2 corresponding to the port 23-2, which is the transmission destination. The transmission processing unit 27-2 searches the transmission flow tables 33-2-1 to X (step S92 in FIG. 10), and as a result, hits the entry that points to the server 13, thereby transmitting the SYN 76-1 to the server 13. In practice, the transmission processing unit 27-2 transmits the SYN 76-1 to the adjacent relay device 20-2 on the path to the server 13.

On the other hand, the control device 21, in response to receiving the SYN 76-1 copied by the relay device 20-1 via the control signal path 15, records reception time Tsyn 77. Additionally, the control device 21 acquires the maximum segment size and the window scale from the Options 52-7 of the SYN 76-1.

The server 13, in response to receiving the SYN 76-1 from the relay device 20-1, performs processing with the TCP socket, and returns the SYN+ACK 76-2, which is the Ethernet frame 53, to the joystick 11 after the elapse of the socket processing time (server) 74.

The relay device 20-1, in response to receiving the SYN+ACK 76-2 returned from the server 13, causes the reception processing unit 25 to perform the search processing illustrated in FIG. 9. The reception processing unit 25 extracts, as the search key, a field such as the MAC dst 50-1 illustrated in FIG. 5 from the SYN+ACK 76-2 received at the port 23-2, and performs the search processing on each entry of the reception flow tables 31-2-1 to X (steps S82 and S85 in FIG. 9).

FIG. 4 illustrates the reception flow table 31-2-1, and the entry 42-2-1-1 is determined to be a hit entry when the bit of the SYN 52-5-2 or the ACK 52-5-5 is enabled in the Flag 52-5 of the received SYN+ACK 76-2.

Note that, in the present embodiment, a method using the ACK bit of the TCP flag will be described. However, since the purpose is to acquire a three-way TCP connection, as another method, for example, a method may be used of acquiring the SYN+ACK 76-2 using, as a key, a value obtained by adding +1 to the Sequence number 52-3 when the SYN 52-5-2 of the Flag 52-5 is enabled.

The reception processing unit 25 continues, as the Action 34, the frame copy to the control port 24 described in the Action 41-1 of the reception flow table 31-2-1 and the search in the reception flow table 31-2-2. Thus, the reception processing unit 25 can continue the search processing to the reception flow table 31-2-2 and subsequent tables, and as a result, can hit the entry that points to the joystick 11. The reception processing unit 25, when hitting the entry that points to the joystick 11 in the search processing, outputs the SYN+ACK 76-2 to the relay processing unit 26. The relay processing unit 26 outputs, in the Port SEL 32, the SYN+ACK 76-2 to the transmission processing unit 27-1 corresponding to the port 23-1, which is the transmission destination. The transmission processing unit 27-1 searches the transmission flow tables 33-1-1 to X (step S92 in FIG. 10), and as a result, hits the entry that points to the joystick 11, thereby transmitting the SYN+ACK 76-2 to the joystick 11.

On the other hand, the control device 21, in response to receiving the SYN+ACK 76-2 copied by the relay device 20-1 via the control signal path 15, records reception time Tsyn+ack 78. Additionally, the control device 21 acquires the maximum segment size and the window scale from the Options 52-7 of the SYN+ACK 76-2.

The joystick 11, in response to receiving the SYN+ACK 76-2 from the relay device 20-1, performs processing with the TCP socket, and returns the ACK 76-3, which is the Ethernet frame 53, to the server 13 after the elapse of the socket processing time (terminal) 75.

The relay device 20-1, in response to receiving the ACK 76-3 returned from the joystick 11, causes the reception processing unit 25 to perform the search processing illustrated in FIG. 9. The reception processing unit 25 extracts, as the search key, a field such as the MAC dst 50-1 illustrated in FIG. 5 from the ACK 76-3 received at the port 23-1, and performs the search processing on each entry of the reception flow tables 31-1-1 to X (steps S82 and S85 in FIG. 9).

FIG. 4 illustrates the reception flow table 31-2-1, and the entry 42-2-1-1 is determined to be a hit entry when the bit of the SYN 52-5-2 or the ACK 52-5-5 is enabled in the Flag 52-5 of the received ACK 76-3.

Note that, in the present embodiment, a method using the ACK bit of the TCP flag will be described. However, since the purpose is to acquire the three-way TCP connection, as another method, for example, a method may be used of acquiring the ACK 76-3 using, as a key, a value obtained by adding +1 to the Sequence number 52-3 and the Ack number 52-4 of the SYN+ACK 76-2.

The reception processing unit 25 continues, as the Action 34, the frame copy to the control port 24 described in the Action 41-1 of the reception flow table 31-1-1 and the search in the reception flow table 31-1-2. Thus, the reception processing unit 25 can continue the search processing to the reception flow table 31-1-2 and subsequent tables, and as a result, can hit the entry that points to the server 13. The reception processing unit 25, when hitting the entry that points to the server 13 in the search processing, outputs the ACK 76-3 to the relay processing unit 26. The relay processing unit 26 outputs, in the Port SEL 32, the ACK 76-3 to the transmission processing unit 27-2 corresponding to the port 23-2, which is the transmission destination. The transmission processing unit 27-2 searches the transmission flow tables 33-2-1 to X (step S92 in FIG. 10), and as a result, hits the entry that points to the server 13, thereby transmitting the ACK 76-3 to the server 13.

On the other hand, the control device 21, in response to receiving the ACK 76-3 copied by the relay device 20-1 via the control signal path 15, records reception time Tack 79. Additionally, the control device 21 determines that the connection processing is continuous from the Sequence number 52-3 of the ACK 76-3 copied by the relay device 20-1, and calculates the delay time between the joystick 11 and the server 13 in accordance with the following formula. The server-side delay time 72 can be calculated by Formula (1), and the network-side delay time 71 can be calculated by Formula (2).

$$Server - side delay time = ( Tsyn + ack ) - Tsyn \qquad ( 1 )$$

$$Network - side delay time = Tack - ( Tsyn + ack ) \qquad ( 2 )$$

However, the server-side delay time 72 calculated by Formula (1) includes the socket processing time (server) 74, and the network-side delay time 71 calculated by Formula (2) includes the socket processing time (terminal) 75. However, in a case where the respective socket processing times have sufficiently smaller values with respect to the respective calculated delay times, the respective socket processing times can be ignored. In a case where the respective socket processing times have no sufficiently smaller values with respect to the respective calculated delay times, for example, the respective calculated delay times may be subjected to subtraction correction as fixed offset values. From the above, the control device 21 can calculate round-trip delay time (hereinafter, referred to as RTT) between the joystick 11 and the server 13 in accordance with Formula (3) below.

$$RTT = ( server - side delay time + network - side delay time ) / 2 \qquad ( 3 )$$

Additionally, the control device 21 can calculate receivable data size (Data size) of the joystick 11 and the server 13 from the Window of the Window 52-6 of the Ethernet frame 53, the maximum segment size, and the window scale in accordance with, for example, Formula (4) below.

Data size=maximum segment

$$Transmission band = Data size \div RTT \qquad ( 5 )$$

Note that, in Formula (4), ROUNDDOWN( ) is an arithmetic operation of rounding down decimal places. The control device 21 can calculate a transmission band in accordance with, for example, Formula (5) below, by using the RTT obtained by Formula (3) and the Data size obtained by Formula (4).

$$size \times ROUNDDOWN ( Window \times window scale \div maximum segment size ) \qquad ( 4 )$$

Note that, the calculation formula of the transmission band is not limited to Formula (5), and the transmission band may be calculated by another calculation formula as long as the RTT and the Data size are used as parameters.

The control device 21 transmits, as a band control value, the transmission band calculated by Formula (5) to the relay device 20-1, and performs setting on the Meter tables 35-1 to 35-n for the entry of the flow 18-1 passing through the relay device 20-1. That is, the control device 21 appropriately updates the contents of the Meter tables 35-1 to 35-n included in the transmission processing unit 27 of the relay device 20-1, thereby controlling the operation of the relay device 20-1. Thus, the control device 21 can apply optimal band control to the flow 18-1. In the first embodiment described above, optimal band control can be achieved by calculating the RTT and the Data size from the three-way TCP handshake in the relay device 20.

As described above, in the relay device 20, the reception processing unit 25 compares the search key of the reception flow table 31 with the Ethernet frame 53 received at a certain one of the ports 23, that is, the field included in the frame, the reception flow table including the search key and the entry in which the Action 41-1 is set, Action 41-1 being the processing to be executed in a case of being applicable to the search key. The reception processing unit 25 determines the processing to be executed on the received frame and the port of the transfer destination. The relay processing unit 26 performs port selection processing such that a frame is transmitted from the port determined by the reception processing unit 25. When the frame is duplicated as processing to be executed by the reception processing unit 25, the relay processing unit 26 transfers a duplicated frame to a transfer destination determined by the reception processing unit 25. The transmission processing unit 27 transmits the frame from the port determined by the reception processing unit 25.

Additionally, the reception processing unit 25 duplicates, as processing to be executed, the frame used at the time of the three-way handshake between the transmission source device and the transmission destination device of the TCP frame that is the frame. The relay processing unit 26 transfers the duplicated frame used at the time of the three-way handshake to the control device 21 including the calculation processing unit 210 that is a transfer destination for calculating the delay time that occurs in the communication system 1. The transmission processing unit 27 performs transmission processing on the frame in accordance with the transmission band set based on the delay time calculated using the frame used at the time of the three-way handshake in the calculation processing unit 210 of the control device 21. In the present embodiment, the control device 21 provided outside the relay device 20 to control the operation of the relay device 20 includes the calculation processing unit 210. In the control device 21, the calculation processing unit 210 calculates the delay time that occurs in the communication system 1 using the TCP frame, which is the frame duplicated in the relay device 20, acquired from the relay device 20, and used at the time of the three-way handshake by the transmission source device and the transmission destination device, and calculates the transmission band to be set in the relay device 20 using the delay time.

As described above, according to the present embodiment, the relay device 20 that implements the packet transfer and control functions efficiently using network resources by using the OpenFlow technology and the packet monitor technology that implement Software Defined Networking (SDN) can cause the control device 21 of the network to grasp, in real time, the band of the flow 18 used in the service. Thus, the control device 21 of the network can set an appropriate band of the flow 18 in the relay device 20, and can achieve efficiency of network resources. Additionally, the control device 21 can set the estimated upper limit band 16-1 illustrated in FIG. 1 from the calculated transmission band, and can grasp the actual available band 16-2 illustrated in FIG. 1 by acquiring, from the relay device 20, the information about the Ethernet frames 53 transmitted and received between the terminal and the server 13 or the Count 41-2 of the reception flow table 31. Consequently, the control device 21 can grasp, in real time, the unused band 16-3 illustrated in FIG. 1.

### Second Embodiment

In a second embodiment, a description will be given of a case where time synchronization is performed between the control device 21 and the relay device 20-1.

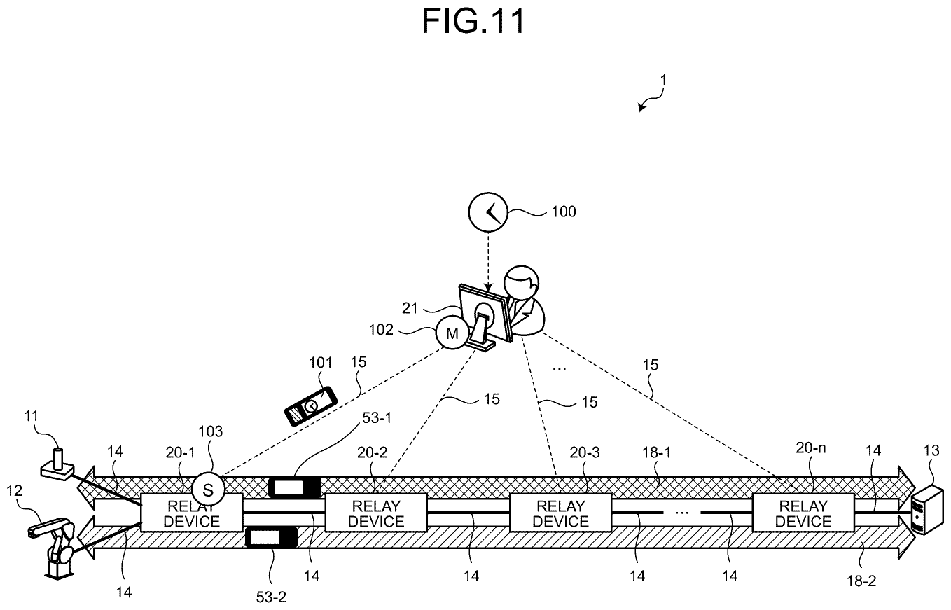

FIG. 11 is a diagram illustrating an exemplary configuration of the communication system 1 according to the second embodiment. The communication system 1 is similar to the communication system 1 according to the first embodiment illustrated in FIG. 1, but in the second embodiment, the control device 21 and the relay device 20-1 perform time synchronization. In response to acquiring time information from a time source 100, the control device 21 serving as a time synchronization master 102 transmits, via the control signal path 15, a time synchronization frame 101 to the relay device 20-1 that is a time synchronization slave 103, thereby providing the time information to the relay device 20-1. Examples of the time synchronization frame 101 include frames defined by IEEE 1588-2019, IEEE 802.1AS, and the like described below.

IEEE Std 1588-2019, “IEEE Standard for a Precision Clock Synchronization Protocol for Networked Measurement and Control Systems”

IEEE Std 802.1AS-2011, “IEEE Standard for Local and Metropolitan area networks-Timing and Synchronization for Time-Sensitive Applications in Bridged Local Area Networks”

Next, the operation will be described. In the first embodiment, the relay device 20-1 copies the Ethernet frames 53-1 and 53-2, which are relayed in the communication between the joystick 11 and the server 13 and used at the time of the three-way TCP handshake, and transfers the copied Ethernet frames 53-1 and 53-2 to the control device 21, but a delay time occurs at the time of transfer via the control signal path 15. As a result, in the control device 21, the delay time on the control signal path 15 is added to the reception times (Tsyn 77, Tsyn+ack 78, and Tack 79) of the Ethernet frames 53-1 and 53-2. Thus, the control device 21 performs correction in accordance with Formula (6) below using a RTT control path that is included in the time synchronization function and is the RTT of the control signal path 15.

$$Reception times of Ethernet frames ( Tsyn 77 , TTsyn + ack 78 , and Tack 79 ) = reception times in control device 21 - ( {RTT}_{control path} \div 2 ) \qquad ( 6 )$$

In the second embodiment described above, the control device 21 can improve the accuracy of the server-side delay time 72 and the network-side delay time 71 by subtracting the delay time on the control signal path 15 added at the time of calculating the reception times (Tsyn 77, Tsyn+ack 78, and Tack 79) in the first embodiment.

### Third Embodiment

In the first embodiment and the second embodiment, the RTT, the transmission band, and the like are calculated by the control device 21. In a third embodiment, a description will be given of a case where the RTT, the transmission band, and the like are calculated by the relay device 20-1.

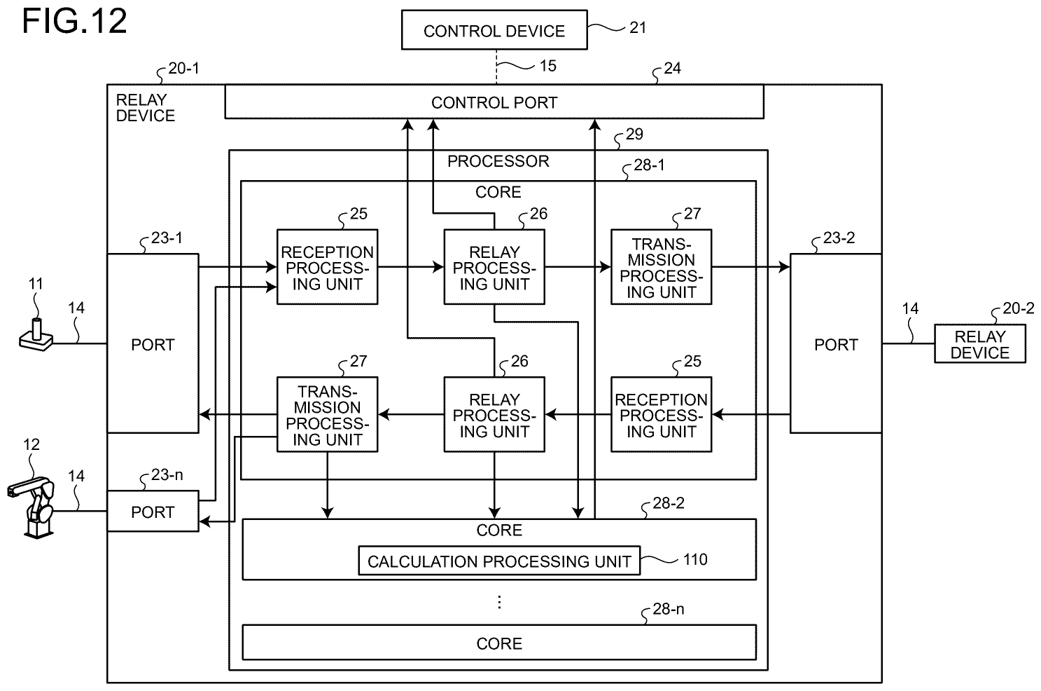

FIG. 12 is a diagram illustrating an exemplary configuration of the relay device 20-1 according to the third embodiment. The relay device 20-1 according to the third embodiment illustrated in FIG. 12 is obtained by adding a calculation processing unit 110 to the core 28-2 of the relay device 20-1 according to the first embodiment illustrated in FIG. 2.

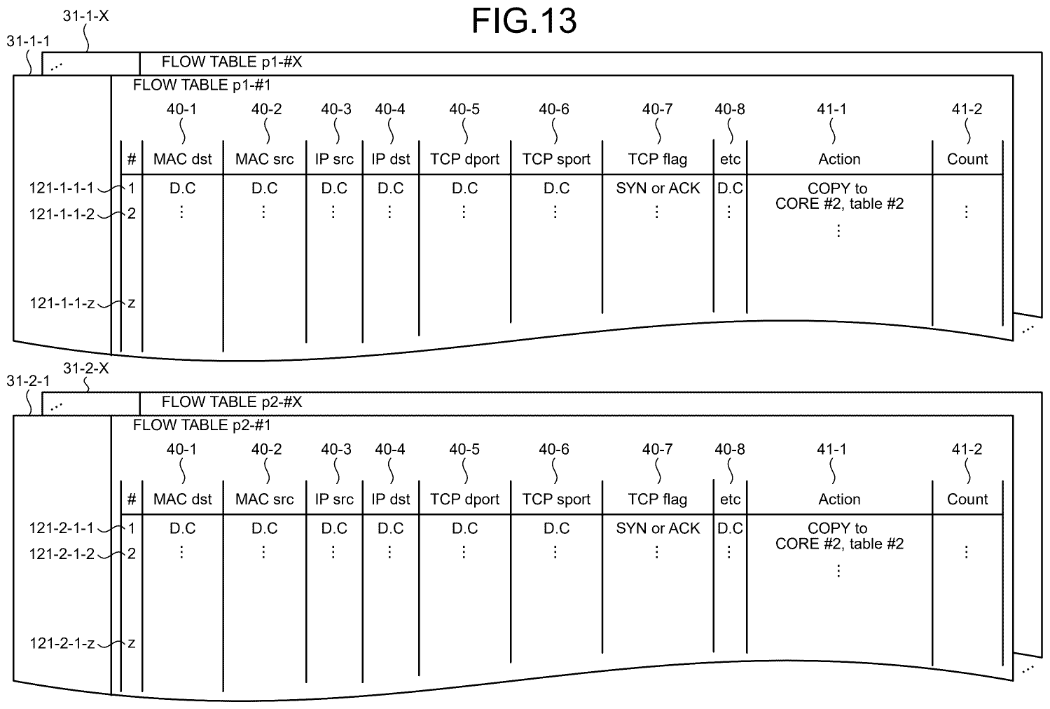

FIG. 13 is a diagram illustrating examples of the reception flow tables 31-1-1 to 31-2-X included in the reception processing units 25 of the relay device 20 according to the third embodiment. In the reception flow tables 31-1-1 to 31-2-X illustrated in FIG. 13, the search keys and the like of the entries 121-1-1-1 to 121-1-1-z, 121-2-1-1 to 121-2-1-z are similar to those of the reception flow tables 31-1-1 to 31-2-X according to the first embodiment illustrated in FIG. 4, but the copy destination specifies the core 28-2 in the Action 41-1.

Next, the operation of the relay device 20 will be described. In the first embodiment and the second embodiment, the relay device 20-1 copies the Ethernet frames 53-1 and 53-2, which are relayed in the communication between the joystick 11 and the server 13 and used at the time of the three-way TCP handshake, and transfers the copied Ethernet frames 53-1 and 53-2 to the control device 21. On the other hand, in the third embodiment, in the relay device 20-1, the reception processing unit 25 of the core 28-1 transfers the copied Ethernet frames 53-1 and 53-2 to the core 28-2 based on the reception flow table 31-1-1 illustrated in FIG. 13. The calculation processing unit 110 of the core 28-2, in response to acquiring the Ethernet frames 53-1 and 53-2 from the reception processing unit 25 of the core 28-1, performs the calculations in accordance with Formulas (1) to (5) performed by the control device 21 in the first embodiment, and notifies the control device 21 of, for example, only the calculated transmission band and the RTT corresponding to the connection pair information.

As described above, the reception processing unit 25 duplicates the frame used at the time of the three-way handshake by the transmission source device and the transmission destination device of the TCP frame that is the frame, as processing to be executed. The relay processing unit 26 transfers the duplicated frame used at the time of the three-way handshake to the core 28-2 including the calculation processing unit 110 that is a transfer destination for calculating a delay time that occurs in the communication system 1. The transmission processing unit 27 performs transmission processing on the frame in accordance with the transmission band in which the delay time is calculated using the frame used at the time of the three-way handshake in the calculation processing unit 110 of the core 28-2 and setting is performed based on the delay time. In the present embodiment, the relay device 20 includes the calculation processing unit 110.

In the above-described third embodiment, the calculation processing performed by the control device 21 in the first embodiment and the second embodiment is performed by the relay device 20-1, thus making it possible to achieve a reduction in a calculation processing load in the control device 21 and the transmission band of the control signal path 15.

### Fourth Embodiment

In a fourth embodiment, a description will be given of a case where, when VLAN tags are added to the Ethernet frames 53-1 and 53-2, a delay time is managed for each of Priority Code Points (PCPs) of the VLAN tags by the control device 21.

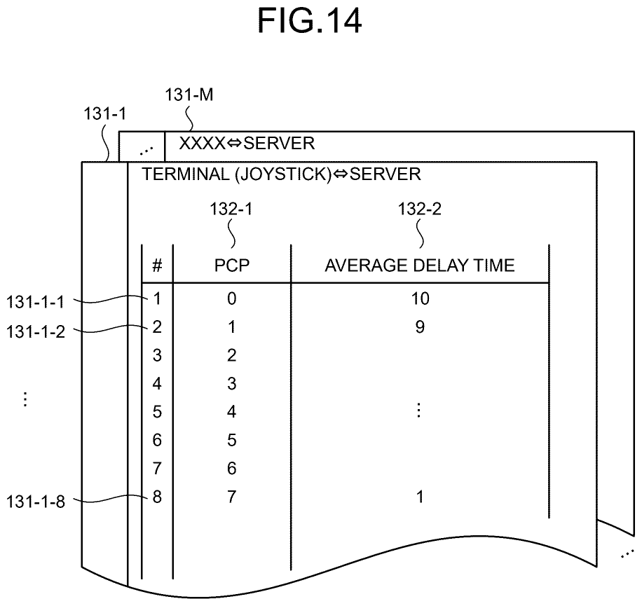

FIG. 14 is a diagram illustrating an example of delay time tables 131-1 to 131-M managed by the control device 21 according to the fourth embodiment. FIG. 14 illustrates the delay time tables 131-1 to 131-M in which an average value of the RTTs calculated in the first embodiment and the like is stored for each value of the field of the PCP 55-2 of the VLAN TAG 50-6 when the VLAN tags are added to the Ethernet frames 53-1 and 53-2. In the example of FIG. 14, specifically, PCP 132-1 and an average delay time 132-2 of the delay time table 131-1 are illustrated. Note I that, in the present embodiment, the description will be given using the PCP 55-2 of the VLAN TAG 50-6, but another Quality of Service (QOS) implementation means such as IP Precedence in IPv4 may be used. Additionally, in the present embodiment, the table is described as a bidirectional table, but the table may be configured separately for each direction, for example, for a direction from the terminal to the server and a direction from the server to the terminal.

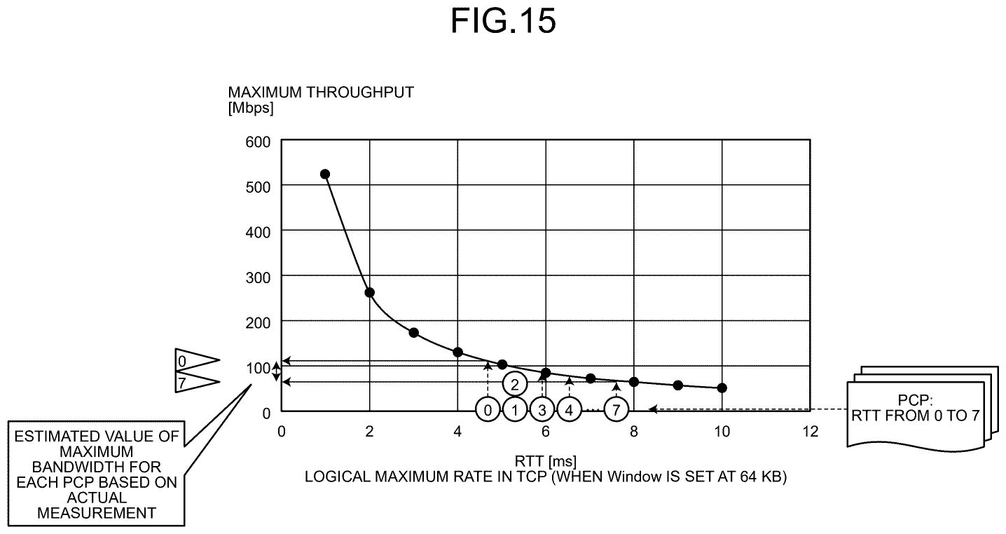

Next, the operation of the control device 21 will be described. The control device 21 manages the RTT value obtained by Formula (3) in the first to third embodiments for each of PCP values of the VLAN tags. The control device 21 can visualize the delay time for each PCP in units of connection pairs and can estimate the maximum throughput for each PCP as illustrated in FIG. 15 by combining Formula (5). FIG. 15 is a diagram illustrating an example of the maximum throughput with respect to the RTT estimated by the control device 21 according to the fourth embodiment.

In this manner, the calculation processing unit 210 of the control device 21 calculates a delay time for each QoS identifier assigned to the Ethernet frame 53, which is the frame. Note that, although the case where the calculation processing unit 210 of the control device 21 calculates a delay time has been described, the present embodiment is not limited thereto. As in the third embodiment, the calculation processing unit 110 of the core 28-2 of the relay device 20 can also calculate a delay time for each QoS identifier assigned to the Ethernet frame 53, which is the frame.

In the fourth embodiment described above, the control device 21 can know the value capable of realizing the delay time and the maximum throughput for each PCP in units of connection pairs, and for example, can control the delay time and the maximum throughput by intentionally changing the PCP value of the corresponding flow in the Action of the relay device 20-1.

### Fifth Embodiment

In a fifth embodiment, a hardware configuration of the relay device 20 will be described. In the relay device 20, the ports 23-1 to 23-n and the control port 24 are communication interfaces capable of communicating with connected devices. The reception processing unit 25, the relay processing unit 26, the transmission processing unit 27, and the calculation processing unit 110 of the third embodiment are implemented by processing circuitry. The processing circuitry may include a memory and a processor that executes a program stored in the memory, or may include dedicated hardware. The processing circuitry is also referred to as a control circuit.

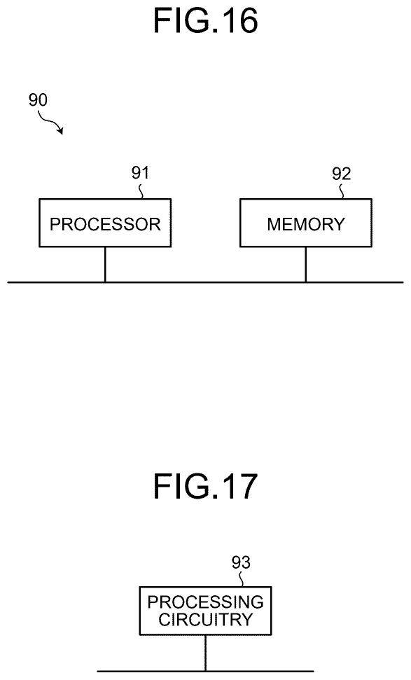

FIG. 16 is a diagram illustrating an exemplary configuration of processing circuitry 90 in a case where a processor 91 and a memory 92 implement processing circuitry that implements the relay device 20 according to the first to fourth embodiments. The processing circuitry 90 illustrated in FIG. 16 is a control circuit, and includes the processor 91 and the memory 92. The processor 91 is the above-described processor 29. In the case where the processing circuitry 90 includes the processor 91 and the memory 92, each function of the processing circuitry 90 is implemented by software, firmware, or a combination of software and firmware. The software or the firmware is described as a program and stored in the memory 92. In the processing circuitry 90, the processor 91 reads and executes the program stored in the memory 92 to implement each function. That is, the processing circuitry 90 includes the memory 92 for storing a program with which processing of the relay device 20 is executed as a result. It can also be said that this program is a program for causing the relay device 20 to execute each function implemented by the processing circuitry 90. This program may be provided by a storage medium storing the program or may be provided by other means such as a communication medium.

It can also be said that the program is a program for causing the relay device 20 to execute: a reception processing step of, by the reception processing unit 25, comparing the field with the search key of the reception flow table 31, the field being included in the Ethernet frame 53 received at a certain one of the ports 23, that is, the frame, the reception flow table 31 including the search key and the entry in which Action 41-1 is set, Action 41-1 being the processing to be executed in a case of being applicable to the search key, and determining the processing to be executed on the received frame and the port of the transfer destination; a relay processing step of, by the relay processing unit 26, performing the port selection processing such that the frame is transmitted from the port determined by the reception processing unit 25, and transferring, when the frame is duplicated as the processing to be executed by the reception processing unit 25, a duplicated frame to a transfer destination determined by the reception processing unit 25; and a transmission processing step of, by the transmission processing unit 27, transmitting the frame from the port determined by the reception processing unit 25.

Here, the processor 91 is, for example, a Central Processing Unit (CPU), a processing unit, an arithmetic unit, a microprocessor, a microcomputer, a Digital Signal Processor (DSP), or the like. Additionally, the memory 92 corresponds to, for example, a nonvolatile or volatile semiconductor memory such as a Random Access Memory (RAM), a Read Only Memory (ROM), a flash memory, an Erasable Programmable ROM (EPROM), or an Electrically EPROM (EEPROM, registered trademark), a magnetic disk, a flexible disk, an optical disk, a compact disk, a mini disk, a Digital Versatile Disc (DVD), or the like.

FIG. 17 is a diagram illustrating an example of processing circuitry 93 in a case where dedicated hardware constitutes processing circuitry that implements the relay device 20 according to the first embodiment. The processing circuitry 93 illustrated in FIG. 17 corresponds to, for example, a single circuit, a combined circuit, a programmed processor, a parallel-programmed processor, an Application Specific Integrated Circuit (ASIC), a Field Programmable Gate Array (FPGA), or a combination thereof. Some of the functions of the processing circuitry may be implemented by dedicated hardware, and the some may be implemented by software or firmware. In this manner, the processing circuitry can implement the above-described functions using dedicated hardware, software, firmware, or a combination thereof.

The relay device according to the present disclosure has an effect of enabling the control device of the network to grasp, in real time, a flow band used in a service.

The configurations described in the above embodiments are illustrative only and may be combined with the other known techniques, the embodiments may be combined with each other, and part of each of the configurations may be omitted or modified without departing from the gist.

What is claimed is:

1. A relay device in a communication system, the relay device including a plurality of ports and to relay a frame, the communication system including the relay device, the relay device comprising:
reception processing circuitry to
compare a field with a search key of a flow table, the field being included in the frame received at a certain one of the ports, the flow table including the search key and an entry in which processing to be executed in a case of being applicable to the search key is set, and
determine processing to be executed on the received frame and a port of a transfer destination;
relay processing circuitry to
perform port selection processing such that the frame is transmitted from the port determined by the reception processing circuitry, and,
when the frame is duplicated as the processing to be executed by the reception processing circuitry, transfer the duplicated frame to a transfer destination determined by the reception processing circuitry; and
transmission processing to transmit the frame from the port determined by the reception processing.

2. The relay device according to claim 1, wherein
the reception processing circuitry duplicates, as the processing to be executed, the frame used at a time of a three-way handshake between a transmission source device and a transmission destination device of a Transmission Control Protocol frame that is the frame,
the relay processing circuitry transfers the duplicated frame used at the time of the three-way handshake to a calculation processing circuitry to calculate a delay time that occurs in the communication system, the calculation processing circuitry being the transfer destination, and
the transmission processing circuitry performs transmission processing on the frame in accordance with a transmission band set based on the delay time calculated using the frame used at the time of the three-way handshake in the calculation processing circuitry.

3. The relay device according to claim 2, wherein
the calculation processing circuitry calculates the delay time for each Quality of Service identifier assigned to the frame.

4. The relay device according to claim 2, wherein
a control device provided outside the relay device to control an operation of the relay device includes the calculation processing circuitry.

5. The relay device according to claim 3, wherein
a control device provided outside the relay device to control an operation of the relay device includes the calculation processing circuitry.

6. The relay device according to claim 4, wherein
the control device is used as a master, the relay device is used as a slave, and time synchronization is performed between the control device and the relay device.

7. The relay device according to claim 5, wherein
the control device is used as a master, the relay device is used as a slave, and time synchronization is performed between the control device and the relay device.

8. The relay device according to claim 2, further comprising
the calculation processing circuitry.

9. The relay device according to claim 3, further comprising
the calculation processing circuitry.

10. A communication system to relay a frame transmitted from a transmission source device to a transmission destination device, the communication system comprising:
the relay device according to claim 4; and
a control device to
calculate, using the frame, a delay time that occurs in the communication system, the frame being duplicated by and acquired from the relay device, the frame being used at a time of a three-way handshake between the transmission source device and the transmission destination device, and
calculate, using the delay time, a transmission band to be set in the relay device.

11. A communication system to relay a frame transmitted from a transmission source device to a transmission destination device, the communication system comprising:
the relay device according to claim 5; and
a control device to
calculate, using the frame, a delay time that occurs in the communication system, the frame being duplicated by and acquired from the relay device, the frame being used at a time of a three-way handshake between the transmission source device and the transmission destination device, and
calculate, using the delay time, a transmission band to be set in the relay device.

12. A control circuit to control a relay device in a communication system, the relay device including a plurality of ports and to relay a frame, the communication system including the relay device, the control circuit for causing the relay device to execute:
comparing a field with a search key of a flow table, the field being included in the frame received at a certain one of the ports, the flow table including the search key and an entry in which processing to be executed in a case of being applicable to the search key is set;
determining processing to be executed on the received frame and a port of a transfer destination;
performing port selection processing such that the frame is transmitted from the determined port;
when the frame is duplicated as the processing to be executed, transferring the duplicated frame to a determined transfer destination; and
transmitting the frame from the determined port.

13. A non-transitory storage medium storing a program for controlling a relay device in a communication system, the relay device including a plurality of ports and to relay a frame, the communication system including the relay device, the program for causing the relay device to execute:
comparing a field with a search key of a flow table, the field being included in the frame received at a certain one of the ports, the flow table including the search key and an entry in which processing to be executed in a case of being applicable to the search key is set;
determining processing to be executed on the received frame and a port of a transfer destination;
performing port selection processing such that the frame is transmitted from the determined port;
when the frame is duplicated as the processing to be executed, transferring the duplicated frame to a determined transfer destination; and
transmitting the frame from the determined port.

14. A relay method for a relay device in a communication system, the relay device including a plurality of ports and to relay a frame, the communication system including the relay device, the relay method comprising:
comparing a field with a search key of a flow table, the field being included in the frame received at a certain one of the ports, the flow table including the search key and an entry in which processing to be executed in a case of being applicable to the search key is set; and
determining processing to be executed on the received frame and a port of a transfer destination;
performing port selection processing such that the frame is transmitted from the determined port;
when the frame is duplicated as the processing to be executed, transferring the duplicated frame to a determined transfer destination; and
transmitting the frame from the determined port.
